(19) United States
(12) Patent Application Publication
(10) Pub. No.: US 2022/0327465 A1
(43) Pub. Date: Oct. 13, 2022

(54) SYSTEM AND METHOD FOR SHIFT SCHEDULING

(71) Applicant: WorkOn Inc., Markham (CA)

(72) Inventor: Muhammad Nouman Khan, Markham (CA)

(21) Appl. No.: 17/714,587

(22) Filed: Apr. 6, 2022

Related U.S. Application Data
(60) Provisional application No. 63/173,760, filed on Apr. 12, 2021.

(51) Int. Cl. G06Q 10/06; G06Q 20/06; G06Q 10/10

(52) U.S. Cl. CPC G06Q 10/063118; G06Q 20/065; G06Q 10/1053

(57) ABSTRACT

Methods and systems are described for interaction and notification of employment opportunities for unskilled workers. Candidate users may complete user profiles and employers may create job postings. Candidate users may receive multiple notifications of employment opportunities within a predetermined geographic range to ensure confirmation of employment, proceed to employment, and receive payment for employment within the system. Employers and candidate users may input an employer or candidate user rank to provide feedback on employment and job performance.

### CROSS-REFERENCE TO PRIOR APPLICATION

This application claims the benefit of priority to U.S. Provisional Patent Application Ser. No. 63/173,760, filed Apr. 12, 2021, which is incorporated herein by reference in its entirety.

### FIELD

The described embodiments relate generally to a system and method for interaction and notification, and specifically to notification for employment opportunities.

### BACKGROUND

The traditional systems and methods used by employment agencies to arrange for the fulfilling of employment opportunities with job seekers are very time consuming and expensive for both employers and job seekers. The agencies tasked with filling employment positions must individually call or contact potential employees, and it is difficult for an agency or an employee to quickly identify eligible candidates for a position.

One challenge in creating employment systems and methods is ensuring employer satisfaction, since potential job candidates may have limited travel abilities, may cancel shifts without notice, or may not show up for shifts at all.

A second challenge in creating employment systems and methods is ensuring that candidate employees receive information and offers of employment that are as relevant to them as possible, since potential candidate may desire not to travel far from their residence.

There remains a need for improved streamlined and easy-to-use systems and methods for fulfilling employment opportunities with suitable candidates.

### SUMMARY

In a first aspect, there is provided a system comprising a network interface in communication with at least one candidate computing device, each candidate computing device corresponding to a candidate user, and a processor in communication with the network interface. The processor is configured to determine at least one proximate candidate computing device from a plurality of enrolled candidate computing devices based on a location associated with the plurality of enrolled candidate computing devices and a predetermined geographic range based on an employer location, transmit, from the network interface to the at least one proximate candidate computing device, a first notification of an employment opportunity, and receive, from the network interface, a corresponding first confirmation from one or more participating candidate computing devices of the at least one proximate candidate computing device, each first confirmation for an indication of interest in the employment opportunity by a respective candidate user. The processor is then configured to transmit, from the network interface, a second notification to a selected participating candidate computing device from the one or more participating candidate computing devices, the second notification comprising details of the employment opportunity for the corresponding candidate user at the selected participating candidate computing device, receive, from the network interface, a second confirmation from the selected participating candidate computing device, the second confirmation for an indication of acceptance of the employment opportunity by the corresponding candidate user at the selected participating candidate computing device, and transmit, from the network interface to the selected participating candidate computing device, a third notification for confirmation of acceptance of the employment opportunity

In one or more embodiments, the location associated with the plurality of enrolled candidate computing devices is based on geographic positioning data of the at least one proximate candidate computing device.

In one or more embodiments, the location associated with the plurality of enrolled candidate computing devices is based on a geographic location specified by the candidate user.

In one or more embodiments, the processor is further configured to determine a list of the one or more participating candidate computing devices, the list ordered based upon an ordering criteria.

In one or more embodiments, the ordering criteria is based on at least one criterion selected from the group consisting of: chronological order based on the time the corresponding candidate user's first confirmation was received, geographic distance of the respective candidate computing device from the employer location, rating of the corresponding candidate user, and prior employment of the corresponding candidate user with the same employer.

In one or more embodiments, the processor is further configured to receive, from the network interface, a rejection of the second notification from the selected participating candidate computing device, the rejection of the second notification for an indication of the corresponding candidate user declining the employment opportunity, determine another participating candidate computing device from the list, the other participating candidate computing device selected from the list based on the ordering criteria, and transmit, from the network interface, a second notification to the other participating candidate computing device from the one or more participating candidate computing devices

In one or more embodiments, the first notification comprises at least one indicator selected from the group consisting of: the distance from the proximate candidate computing device to the employer location, and the hourly wage of the employment opportunity.

In one or more embodiments, the second notification comprises at least one indicator selected from the group consisting of: company details, an exact location of the employment opportunity, scheduling information, type of assignment, and company ranking.

In one or more embodiments, the processor is further configured to determine an elapsed time indicator between a transmission of the second notification and an arrival of the second confirmation wherein if the elapsed time indicator is greater than a predetermined threshold, the processor is configured to refuse the second confirmation from the participating candidate computing device.

In one or more embodiments, the third notification is in the form of an automated phone call.

In one or more embodiments, the processor is configured to determine the selected participating candidate computing device based on a number of requested candidate users of the employment opportunity.

In one or more embodiments, after the employment opportunity is completed by the candidate user, the processor is configured to receive an employer rank indicator from the at least one candidate computing device, the employer rank indicator corresponding to the employment opportunity.

In one or more embodiments, after the employment opportunity is completed by the candidate user, the processor is configured to receive an employee rank indicator from the network interface, the employee rank corresponding to the candidate user.

In one or more embodiments, after the employment opportunity is completed by the candidate user, the processor is configured to transmit a payment request to a payment processor for fulfilling payment to the candidate user for the employment opportunity within the same day as the employment opportunity.

In a second aspect, there is provided a computer-implemented method for notification, the method comprising determining, at least one proximate candidate computing device from a plurality of enrolled candidate computing devices based on a location associated with the plurality of enrolled candidate computing devices and a predetermined geographic range based on an employer location, transmitting, from the network interface to the at least one proximate candidate computing device, a first notification of an employment opportunity, and receiving, from the network interface, a corresponding first confirmation from one or more participating candidate computing devices of the at least one proximate candidate computing device, each first confirmation for an indication of interest in the employment opportunity by a respective candidate user. The method further comprises transmitting, from the network interface, a second notification to a selected participating candidate computing device from the one or more participating candidate computing devices, the second notification comprising details of the employment opportunity for the corresponding candidate user at the selected participating candidate computing device, receiving, from the network interface, a second confirmation from the selected participating candidate computing device, the second confirmation for an indication of acceptance of the employment opportunity by the corresponding candidate user at the selected participating candidate computing device, and transmitting, from the network interface to the selected participating candidate computing device, a third notification for confirmation of acceptance of the employment opportunity.

In one or more embodiments, the location associated with the plurality of enrolled candidate computing devices is based on geographic positioning data of the at least one proximate candidate computing system.

In one or more embodiments, the location associated with the plurality of enrolled candidate computing devices is based on a geographic location specified by the candidate user.

In one or more embodiments, the method further comprises determining a list of the one or more participating candidate computing devices, the list ordered based upon an ordering criteria.

In one or more embodiments, the ordering criteria is based on at least one criterion selected from the group consisting of: chronological order based on the time the corresponding candidate user's first confirmation was received, geographic distance of the respective candidate computing device from the employer location, rating of the corresponding candidate user, and prior employment of the corresponding candidate user with the same employer.

In one or more embodiments, the method further comprises receiving, from the network interface, a rejection of the second notification from the selected participating candidate computing device, the rejection of the second notification for an indication of the corresponding candidate user declining the employment opportunity, determining another participating candidate computing device from the list, the other participating candidate computing device selected from the list based on the ordering criteria, and transmitting, from the network interface, a second notification to the other participating candidate computing device from the one or more participating candidate computing device.

In one or more embodiments, the first notification comprises at least one indicator selected from the group consisting of: the distance from the proximate candidate computing device to the employer location, and the hourly wage of the employment opportunity.

In one or more embodiments, the second notification comprises at least one indicator selected from the group consisting of: company details, an exact location of the employment opportunity, scheduling information, type of assignment, and company ranking.

In one or more embodiments, the method further comprises determining an elapsed time indicator between a transmission of the second notification and an arrival of the second confirmation wherein if the elapsed time indicator is greater than a predetermined threshold, the second confirmation from the participating candidate computing device is refused.

In one or more embodiments, the third notification is in the form of an automated phone call.

In one or more embodiments, the method further comprises determining the selected participating candidate computing device based on a number of requested candidate users of the employment opportunity.

In one or more embodiments, after the employment opportunity is completed by the candidate user, the method further comprises receiving an employer rank indicator from the at least one candidate computing device, the employer rank indicator corresponding to the employment opportunity.

In one or more embodiments, after the employment opportunity is completed by the candidate user, the method further comprises receiving an employee rank indicator from the network interface, the employee rank indicator corresponding to the candidate user.

In one or more embodiments, after the employment opportunity is completed by the candidate user, the method further comprises transmitting a payment request to a payment processor from the network interface, the payment request configured to fulfill payment to the candidate user for the employment opportunity within the same day as the employment opportunity.

In a third aspect, there is provided a notification system, the system comprising at least one user input device, each user input device corresponding to a candidate user, a network interface in communication with a server, and a processor in communication with the user input device and the network interface. The processor is configured to transmit, from at least one proximate user input device from a plurality of enrolled user input devices, a location associated with the plurality of enrolled user input devices, receive, at the at least one proximate user input device, a first notification of an employment opportunity, receive, at the at least one proximate user input device, a user input indicating a corresponding candidate users interest of the first notification of the employment opportunity by the corresponding candidate user, and transmit, from the at least one participating user input device, a corresponding first confirmation of the first notification of the employment opportunity. The processor is further configured to receive, at a selected participating user input device in the at least one participating user input device, a second notification comprising details of the employment opportunity, receive, at the selected participating user input device, a user input indicating the corresponding candidate users acceptance of the second notification of the employment opportunity by the corresponding candidate user, transmit, from the selected participating user input device, a second confirmation of the second notification of the employment opportunity, receive, at the selected participating user input device, a third notification for confirmation of acceptance of the employment opportunity, receive, at the selected participating user input device, a user input indicating the corresponding candidate users confirmation of the third notification of the employment opportunity, and transmit, from the selected participating user input device, a third confirmation of the third notification of the employment opportunity.

In one or more embodiments, the location associated with the plurality of enrolled user input devices is based on geographic positioning data of the at least one proximate user input device.

In one or more embodiments, the location associated with the at least one proximate user input device is based on a geographic location specified by the candidate user.

In one or more embodiments, the network interface is configured to determine a list of one or more participating user input devices, the list ordered based upon an ordering criteria.

In one or more embodiments, the ordering criteria is based on at least one criterion selected from the group consisting of: chronological order based on the time the user input indicating the corresponding candidate user's first confirmation was transmit, geographic distance of the respective user input device from the employer location, rating of the corresponding candidate user, and prior employment of the corresponding candidate user with the same employer.

In one or more embodiments, the processor is further configured to transmit, from the selected participating user input device, a rejection of the second notification, the rejection of the second notification for an indication of the corresponding candidate user declining the employment opportunity, determine another participating user input device from the list, the other participating user input device selected from the list based on the ordering criteria, and receive, at the other participating user input device, a second notification to the other participating user input device from the one or more participating user input devices.

In one or more embodiments, the first notification comprises at least one indicator selected from the group consisting of: the distance from the proximate user input device to the employer location, and the hourly wage of the employment opportunity.

In one or more embodiments, the second notification comprises at least one indicator selected from the group consisting of: company details, an exact location of the employment opportunity, scheduling information, type of assignment, and company ranking.

In one or more embodiments, the processor is further configured to determine an elapsed time indicator between an arrival of the second notification and a transmission of the second confirmation wherein if the elapsed time indicator is greater than a predetermined threshold, the processor is configured to refuse the second confirmation from the participating user input device.

In one or more embodiments, the third notification is in the form of an automated phone call.

In one or more embodiments, the processor is configured to determine the selected participating user input device based on a number of requested candidate users of the employment opportunity.

In one or more embodiments, after the employment opportunity is completed by the candidate user, the processor is configured to receive an employer rank indicator from the at least one user input device, the employer rank indicator corresponding to the employment opportunity.

In one or more embodiments, after the employment opportunity is completed by the candidate user, the processor is configured to receive an employee rank indicator from the network interface, the employee rank corresponding to the candidate user.

In one or more embodiments, after the employment opportunity is completed by the candidate user, the processor is configured to transmit a payment request to a payment processor for fulfilling payment to the candidate user for the employment opportunity within the same day as the employment opportunity.

In a fourth aspect, there is a provided a notification method, the method comprising transmitting, from at least one proximate user input device from a plurality of enrolled user input devices, the location associated with the plurality of enrolled user input devices, receiving, at the at least one proximate user input device, a first notification of the employment opportunity, receiving, at the at least one proximate user input device, a user input indicating a corresponding candidate users interest of the first notification of the employment opportunity by the corresponding candidate user, transmitting, from the at least one participating user input device, a first corresponding confirmation of the first notification of the employment opportunity, receiving, at a selected participating user input device in the at least one participating user input device, a second notification comprising details of the employment opportunity, and receiving, at the selected participating user input device, a user input indicating the corresponding candidate users acceptance of the second notification of the employment opportunity by the corresponding candidate user. The method further comprises transmitting, from the selected participating user input device, a second confirmation of the second notification of the employment opportunity, receiving, at the selected participating user input device, a third notification for confirmation of acceptance of the employment opportunity, receiving, at the selected participating user input device, a user input indicating the corresponding candidate users confirmation of the third notification of the employment opportunity, and transmitting, from the selected participating user input device, a third confirmation of the third notification of the employment opportunity

In one or more embodiments, the location associated with the plurality of enrolled user input devices is based on geographic positioning data of the at least one proximate user input device.

In one or more embodiments, the location associated with the plurality of enrolled user input devices is based on a geographic location specified by the candidate user.

In one or more embodiments, a network interface in communication with the at least one user input device is configured to determine a list of one or more participating user input devices, the list ordered based upon an ordering criteria.

In one or more embodiments, the ordering criteria is based on at least one criterion selected from the group consisting of: chronological order based on the time the corresponding user input indicating the corresponding candidate user's first confirmation was transmit, geographic distance of the respective user input device from the employer location, rating of the corresponding candidate user, and prior employment of the corresponding candidate user with the same employer.

In one or more embodiments, the method further comprises transmitting, from the selected participating user input device, a rejection of the second notification, the rejection of the second notification for an indication of the corresponding candidate user declining the employment opportunity, determining another participating user input device, the other participating user input device selected from the list based on the ordering criteria, and receiving, at the other participating user input device, a second notification to the other participating user input device in the one or more participating user input devices.

In one or more embodiments, the first notification comprises at least one indicator selected from the group consisting of: the distance from the proximate user input device to the employer location, and the hourly wage of the employment opportunity.

In one or more embodiments, the second notification comprises at least one indicator selected from the group consisting of: company details, the exact location of the employment opportunity, scheduling information, type of assignment, and company ranking.

In one or more embodiments, wherein the method further comprises determining an elapsed time indicator between an arrival of the second notification and a transmission of the second confirmation wherein if the elapsed time indicator is greater than a predetermined threshold, the second confirmation from the participating user input device is refused.

In one or more embodiments, the third notification is in the form of an automated phone call.

In one or more embodiments, the method further comprises determining the selected participating user input device based on a number of requested candidate users of the employment opportunity.

In one or more embodiments, after the employment opportunity is completed by the candidate user, the method further comprises transmitting a corresponding user input of an employer rank indicator from the at least one user input device, the employer rank indicator corresponding to the employment opportunity.

In one or more embodiments, after the employment opportunity is completed by the candidate user, the method further comprises receiving an employee rank indicator from the network interface, the employee rank indicator representing the candidate user.

In one or more embodiments, after the employment opportunity is completed by the candidate user, the method further comprises transmitting a payment request to a payment processor from the network interface, the payment request configured to fulfill payment to the candidate user for the employment opportunity within the same day as the employment opportunity.

### BRIEF DESCRIPTION OF THE DRAWINGS

A preferred embodiment of the present invention will now be described in detail with reference to the drawings, in which:

FIG. 1 is a block diagram of a notification system in accordance with one or more embodiments;

FIG. 2a is a system diagram for a user device for interaction and notification in accordance with one or more embodiments;

FIG. 2b is another system diagram for a processor for interaction and notification in accordance with one or more embodiments;

FIG. 3 is a scenario diagram for interaction, notification and payment in accordance with one or more embodiments;

FIG. 4 is a method diagram for interaction and notification in accordance with one or more embodiments;

FIG. 5 is a user interface diagram for interaction and notification in accordance with one or more embodiments;

FIG. 6 is a user interface diagram for interaction and notification in accordance with one or more embodiments;

FIG. 7 is another user interface diagram for interaction and notification in accordance with one or more embodiments;

FIG. 8 is another user interface diagram for interaction and notification in accordance with one or more embodiments;

FIG. 9 is another user interface diagram for interaction and notification in accordance with one or more embodiments;

FIG. 10 is another user interface diagram for interaction and notification in accordance with one or more embodiments;

FIG. 11 is another user interface diagram for interaction and notification in accordance with one or more embodiments;

FIG. 12 is another user interface diagram for interaction and notification in accordance with one or more embodiments;

FIG. 13 is another user interface diagram for interaction and notification in accordance with one or more embodiments;

FIG. 14 is another user interface diagram for interaction and notification in accordance with one or more embodiments;

FIG. 15 is another user interface diagram for interaction and notification in accordance with one or more embodiments;

FIG. 16 is a method diagram for interaction and notification in accordance with one or more embodiments.

### DESCRIPTION OF EXEMPLARY EMBODIMENTS

It will be appreciated that numerous specific details are set forth in order to provide a thorough understanding of the example embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description and the drawings are not to be considered as limiting the scope of the embodiments described herein in any way, but rather as merely describing the implementation of the various embodiments described herein.

It should be noted that terms of degree such as “substantially”, “about” and “approximately” when used herein mean a reasonable amount of deviation of the modified term such that the end result is not significantly changed. These terms of degree should be construed as including a deviation of the modified term if this deviation would not negate the meaning of the term it modifies.

In addition, as used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

The embodiments of the systems and methods described herein may be implemented in hardware or software, or a combination of both. These embodiments may be implemented in computer programs executing on programmable computers, each computer including at least one processor, a data storage system (including volatile memory or non-volatile memory or other data storage elements or a combination thereof), and at least one communication interface. For example and without limitation, the programmable computers (referred to below as computing devices) may be a server, network appliance, embedded device, computer expansion module, a personal computer, laptop, personal data assistant, cellular telephone, smart-phone device, tablet computer, a wireless device or any other computing device capable of being configured to carry out the methods described herein.

In some embodiments, the communication interface may be a network communication interface. In embodiments in which elements are combined, the communication interface may be a software communication interface, such as those for inter-process communication (IPC). In still other embodiments, there may be a combination of communication interfaces implemented such as hardware, software, and combinations thereof.

Program code may be applied to input data to perform the functions described herein and to generate output information. The output information is applied to one or more output devices, in known fashion.

Each program may be implemented in a high level procedural or object-oriented programming and/or scripting language, or both, to communicate with a computer system. However, the programs may be implemented in assembly or machine language, if desired. In any case, the language may be a compiled or interpreted language. Each such computer program may be stored on a storage media or a device (e.g. ROM, magnetic disk, optical disc) readable by a general or special purpose programmable computer, for configuring and operating the computer when the storage media or device is read by the computer to perform the procedures described herein. Embodiments of the system may also be considered to be implemented as a non-transitory computer-readable storage medium, configured with a computer program, where the storage medium so configured causes a computer to operate in a specific and predefined manner to perform the functions described herein.

Furthermore, the system, processes and methods of the described embodiments are capable of being distributed in a computer program product comprising a computer readable medium that bears computer usable instructions for one or more processors. The medium may be provided in various forms, including one or more diskettes, compact disks, tapes, chips, wireline transmissions, satellite transmissions, internet transmission or downloads, magnetic and electronic storage media, digital and analog signals, and the like. The computer useable instructions may also be in various forms, including compiled and non-compiled code.

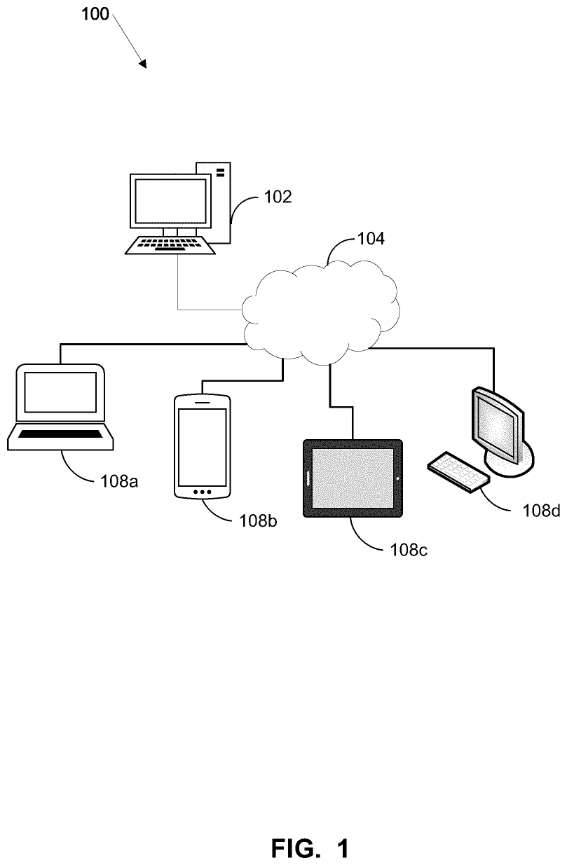

Reference is first made to FIG. 1, which illustrates a schematic block diagram of an employment system 100. The employment system 100 includes a server 102, a network interface 104, and a plurality of user computing devices 108.

Candidate users (not shown) may each operate candidate computing devices 108a-108d in order to participate in employment opportunities. The candidate users may be a potential employer or a potential employee. The candidate users may input the requested information for a profile, be put in contact with an employment opportunity, and participate in said employment opportunity.

As shown, the employment system 100 includes a network interface 104 for connecting the server 102, and the plurality of user computing devices 108.

Network interface 104 may be any network or network components capable of carrying data including the Internet, Ethernet, fiber optics, satellite, mobile, wireless (e.g. Wi-Fi, WiMAX), SS7 signaling network, fixed line, local area network (LAN), wide area network (WAN0), a direct point-to-point connection, mobile data networks (e.g., Universal Mobile Telecommunications System (UMTS), 3GPP Long-Term Evolution Advanced (LTE Advanced), Worldwide Interoperability for Microwave Access (WiMAX), etc.) and others, including any combination of these.

A user computing device 108 may be any two-way communication device with capabilities to communicate with other devices. A user computing device 108 may be any mobile device such as mobile devices running the Google® Android® operating system or Apple® iOS® operating system. The computing device may be a personal computer, a workstation, a server, a portable computer, a mobile phone, a laptop wireless coupled to an access point (e.g., a wireless router, a cellular communications tower, etc.), a wirelessly enabled personal data assistant (PDA) or a smart phone, a terminal, a tablet computer, a game console over a wired or wireless connection, a WAP phone, or a combination of these.

Each user computing device 108 may include and execute a user application, such as an employment opportunity application, to receive notifications. The user application may be a web application provided by server 102 of employment system 100, or it may be an application installed on the candidate user computing device 108, for example, via an app store such as Google® Play® or the Apple® App Store®.

By way of an example, the employment system 100 illustrates four user computing devices, namely a first user computing device 108a, a second user computing device 108b, a third user computing device 108c and a fourth user computing device 108d. The employment system 100 can include any number of user computing devices 108. The user computing devices 108 may be used by a candidate user, and may therefore be a candidate user computing device. The user computing devices may also be used by an employee, which may be referred to as an employee computing device.

As shown, the user computing devices 108 are configured to communication with employment system 100 using network interface 104. For example, employment system 100 may provide a web application or Application Programming Interface (API) endpoint for an application running on user devices 108.

The employment system 100 is any networked computing device or system, including a processor and a memory, and is capable of communication with a network, such as network interface 104. The employment system 100 may include one or more systems or devices that are communicably coupled to each other.

The employment system 100 manages the accounts of various users of the employment opportunity system 100 and facilitates the opportunities for employment exchange between employee users and employer users. For example, the employment system 100 may allow candidate users to create user accounts, add user profile information associated with a user account, upload images, etc. The plurality of user accounts, the plurality of user profile information, the plurality of uploaded images, and the plurality of employment opportunities, among other things, may be stored in the server 102.

The server 102 may store user information and other related information, as discussed in detail below. The server 102 may include a Structured Query Language (SQL) such as PostgreSQL or MySQL or a not only SQL (NoSQL) database such as MongoDB, or Graph Databases, etc.

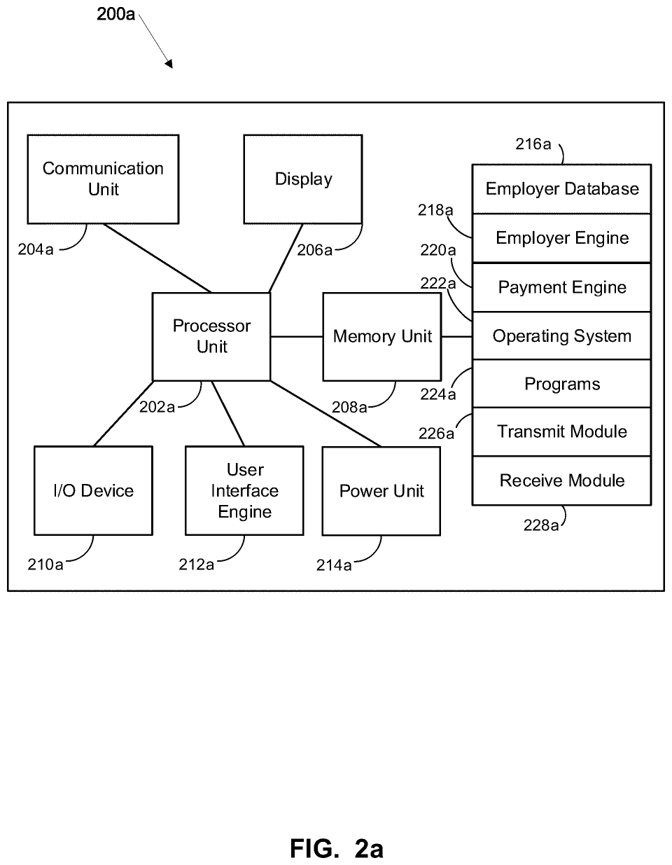

Reference is next made to FIG. 2a, which shows a system diagram of a candidate user computing device 200a, such as user computing device 108a from FIG. 1, according to an example. The candidate user computing device 200a includes a processor unit 202a, a communication unit 204a, a memory unit 208a, an I/O unit 210a, a user interface engine 212a, and a power unit 214a. The candidate user computing device 200a may have a display 206a, which may also be a user input device such as a touchscreen.

The processor unit 202a controls the operation of the candidate user computing device 200a. The processor unit 202a can be any suitable processor, controller or digital signal processor that can provide sufficient processing power depending on the configuration, purposes and requirements of the candidate user computing device 200a as is known by those skilled in the art. For example, the processor unit 202a may be a high-performance general processor. In alternative embodiments, the processor unit 202a can include more than one processor with each processor being configured to perform different dedicated tasks. In alternative embodiments, it may be possible to use specialized hardware to provide some of the functions provided by the processor unit 202a. For example, the processor unit 202a may include a standard processor, such as an Intel® processor, an ARM® processor or a microcontroller.

The communication unit 204a can include wired or wireless connection capabilities. The communication unit 204a can include a radio that communicates utilizing 4G, LTE, 5G, CDMA, GSM, GPRS or Bluetooth protocol according to standards such as IEEE 802.11a, 802.11b, 802.11g, or 802.11n, etc. The communication unit 204a can be used by the user device 100 to communicate with other devices or computers.

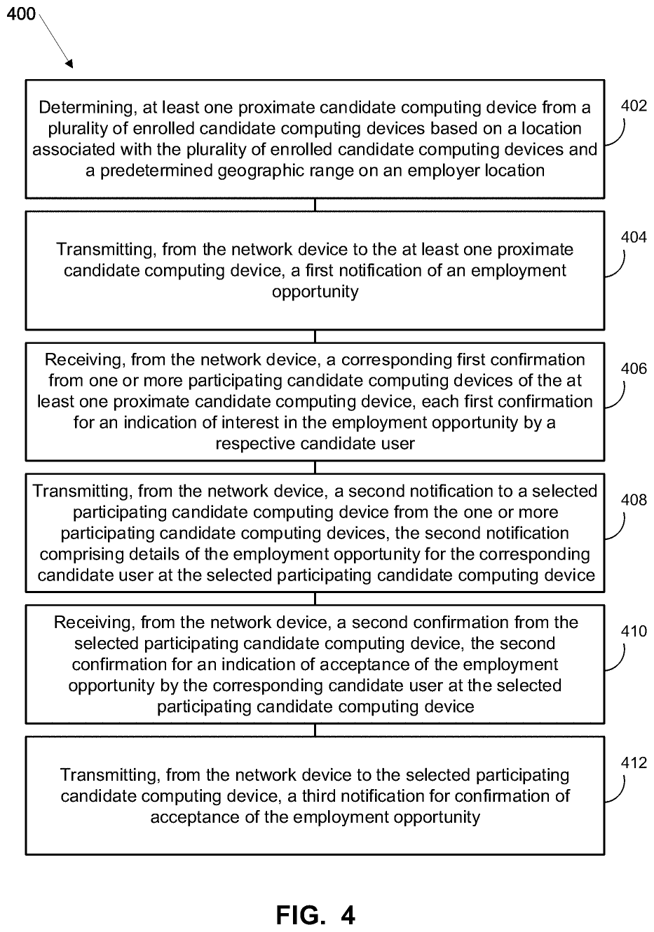

The processor unit 202a can also execute a user interface engine 212a that is used to generate various user interfaces, some examples of which are shown and described herein, such as interfaces shown in FIGS. 5 to 15.

The user interface engine 212a is configured to generate interfaces for users to view potential employment opportunities, receive incoming alerts or calls of potential employment opportunities, receive payment for completing an employment opportunity, or other types of interfaces. The various interfaces generated by the user interface engine 212a are displayed to the user on display 206a.

The display 206a may be an LED or LCD based display and may be a touch sensitive user input device.

The I/O unit 210a can include at least one of a mouse, a keyboard, a touch screen, a thumbwheel, a track-pad, a track-ball, a card-reader, voice recognition software and the like again depending on the particular implementation of the user device 200a. In some cases, some of these components can be integrated with one another.

The power unit 214a can be any suitable power source that provides power to the user device 200a such as a power adaptor or a rechargeable battery pack depending on the implementation of the candidate user computing device 200a as is known by those skilled in the art.

The memory unit 208a comprises software code for implementing an employer database 216a, employer engine 218a, payment engine 220a, operating system 222a, programs 224a, transmit module 226a and receive module 228a.

The memory unit 208a can include RAM, ROM, one or more hard drives, one or more flash drives or some other suitable data storage elements such as disk drives, etc. The memory unit 208a is used to store an operating system 222a and programs 224a as is commonly known by those skilled in the art. For instance, the operating system 222a provides various basic operational processes for the user device 200a. For example, the operating system 222a may be a mobile operating system such as Google® Android operating system, or Apple® iOS operating system, or another operating system.

The employer database 216a may be provided at the user device 200a, or alternatively may be provided by a server (see e.g. server 102 in FIG. 1). Where the databases are provided by a server, then the user devices may access employee or employer information as required via an Application Programming Interface (API) using communication unit 204a.

The programs 224a include various user programs so that a user can interact with the user device 200a to perform various functions such as, but not limited to, interacting with the user device, and displaying information and notifications to the user.

The employer database 216a may be configured to define and store information, such as employer device information, employer profile information, employer job information, banking information, or other information related to the employers in the system.

The employer engine 218a may be configured to obtain information from the employer database 216a to match employment opportunities with employees. The matching process may include comparing geographic locations related to candidate user computing devices with employer locations, assignment types, safety requirements, or any other requirements made by the employer.

The payment engine 220a may be configured to obtain information from the employer database 216a to enable payment to occur within the system. The information obtained may be credit card information, bank account numbers, transit numbers, institution numbers, or any other banking information required to complete payment transactions.

The operating system 222a provides various basic operational processes for the operation of the employment system 100. For example, the operating system 222a may be a Microsoft® Windows Server® operating system, or a Linux®-based operating system, Unix® or macOS® Apple iOS or Google Android, or another operating system. In an alternate embodiment, the operating system 222a may be one such as Microsoft® Windows operating system, a Linux®-based operating system, Unix®, or macOS®

The transmit module 224a is configured to, in collaboration with other components of the candidate user computing device 200, configure and transmit information signals for transmittal. The transmit module 224a encodes the device's data into an information signal and transmits the information signals. As discussed herein, the transmit module 224a is configured to transmit the information signal when a candidate user has indicated his/her intention to accept an employment opportunity. The transmit module 224a is further configured to transmit indications of interest of an employment opportunity, indications of acceptance of an employment opportunity and confirmation of acceptance of an employment opportunity. The information signals are transmitted over network 104 of FIG. 1.

The receive module 226a is configured to receive one or more information signals from one or more other devices. The receive module 226a, in collaboration with other components of the candidate user computing device 200a, is configured to receive an information signal to notify candidate users of employment opportunities. The receive module is further configured to receive first, second and third employment alerts of employment opportunities.

Reference is next made to FIG. 2b, which shows a system diagram of an employer computing device 200b, such as user computing device 108a from FIG. 1, according to an example. The employer user computing device 200a may correspond to the employee computing device 200a, except as noted. The employer user computing device 200b includes a processor unit 202b, a communication unit 204b, a memory unit 208b, an I/O unit 210b, a user interface engine 212b, and a power unit 214b. The employer computing device 200b may have a display 206b, which may also be a user input device such as a touchscreen.

The processor unit 202b, communication unit 204b, memory unit 208b, I/O unit 210b, user interface engine 212b, power unit 214b and display 206b may all be the same as described in FIG. 2a.

The employee database 216b may be configured to define and store information, such as candidate user computing device information, candidate user profile information, banking information, or other information related to the candidate users in the system.

The employer database 216b may be provided at the user device 200b, or alternatively may be provided by a server (see e.g. server 102 in FIG. 1). Where the databases are provided by a server, then the user devices may access employee or employer information as required via an Application Programming Interface (API) using communication unit 204b.

The employee engine 218b may be configured to obtain information from the employee database 216b to match employees with employment opportunities. The matching process may include comparing geographic locations related to candidate user computing devices with employer locations, assignment types, safety requirements, or any other requirements made by the employer.

The payment engine 220b may be configured to obtain information from the employee database 216b to enable payment to occur within the system. The information obtained may be credit card information, bank account numbers, transit numbers, institution numbers, or any other banking information required to complete payment transactions.

The operating system 222b provides various basic operational processes for the operation of the employment system 100. For example, the operating system 222b may be a Microsoft® Windows Server® operating system, or a Linux®-based operating system, Unix® or macOS®, or another operating system.

The transmit module 224b is configured to, in collaboration with other components of the employer computing device 200b, configure and transmit information signals for transmittal. The transmit module 224b encodes the device's data into an information signal and transmits the information signals. As discussed herein, the transmit module 224b is configured to transmit the information signal when a candidate user has indicated his/her intention to accept an employment opportunity. The transmit module 224b is further configured to transmit indications of interest of an employment opportunity, indications of acceptance of an employment opportunity and confirmation of acceptance of an employment opportunity. The information signals are transmitted over a short-distance wireless communication network, such as network 104 of FIG. 1.

The receive module 226b is configured to receive one or more information signals from one or more other devices. The receive module 226b, in collaboration with other components of the employer computing device 200b, is configured to receive an information signal to notify candidate users of employment opportunities. The receive module is further configured to receive first, second and third employment alerts of employment opportunities.

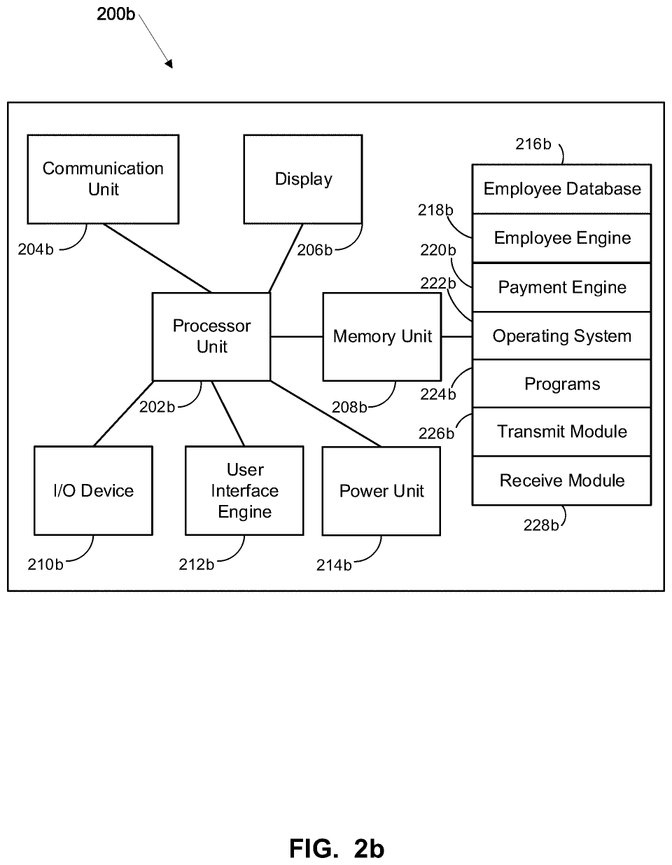

Referring next to FIG. 3, there is shown a scenario diagram 300 for interaction, notification and payment in accordance with one or more embodiments.

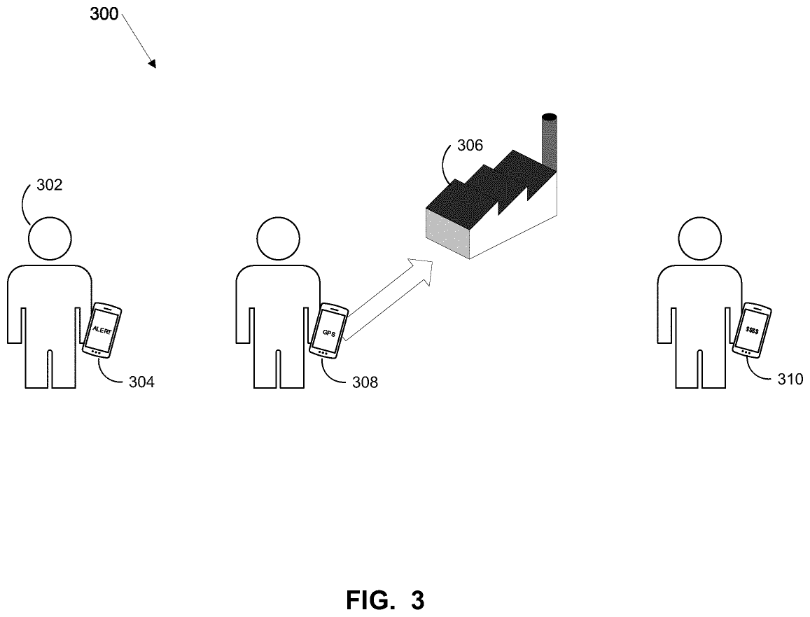

The scenario diagram 300 shown provides an example view of the employment system wherein a candidate user receives a notification, proceeds to the place of business, and receives a payment for the employment completed. A candidate user 302 operates a candidate user computing device 304 running a software application that includes the notification system described in FIG. 4 as shown. The candidate user computing device 304 receives a notification for an employment opportunity based on certain factors, such as, for example, location associated with the candidate user computing device, educational background associated with the candidate user computing device, type of acceptable employment, minimum wage identified, full/part time preference, shift time preference, training qualifications, drivers license requirements, rating of the candidate user, or any other factor indicated by a user.

In at least one embodiment, the candidate user computing device 304 receives a notification for an employment opportunity based on a location associated with the candidate user computing device and a predetermined geographic range based on an employment location 306.

In at least one embodiment, the candidate user computing device 304 may receive a notification for an employment opportunity based on the indication of preferences by the employer. The preferences may be weighted. The notification may be received if there is a match between information within a candidate user 302 profile and preferences indicated by the employer. Some examples of such preferences may include educational background, preferred employment type selected, rating of the candidate user, shift time preference, full/part time preference, training qualifications, drivers license requirements, or any other preferences indicated by the employer.

In another embodiment, the candidate user computing device 304 may receive a notification for an employment opportunity based on the indication of preferences by the candidate user 302. The preferences may be weighted. The notification may be received if there is a match between information within an employer profile and preferences indicated by the candidate user 302. Some examples of such preferences may include minimum wage identified, shift time preference, full/part time preference, type of assignment, distance from employment location, rating of the employer, or any other preferences indicated by the candidate user 302.

The notification may be output to the candidate user 302 in the form of an alert, call, text message, email, or any other form of notification on the candidate user computing device 304. The candidate user 302 may accept the notification for the employment opportunity, and travel to the employment location 306. After employment at the employment location 306 has been completed, the candidate user 302 may receive payment for the employment opportunity on the candidate user computing device 308.

The notification to the candidate user 302 may have a predetermined timeout period, after which the notification may be unavailable to candidate user 302 to accept. After the predetermined timeout period for candidate user 302, then the notification may be sent to other candidate users.

The predetermined timeout period may be an elapsed time or countdown. The predetermined timeout period may be dynamically configurable. In one example, the predetermined timeout period may be 30 seconds, i.e. if a notification to a candidate user 302 is not accepted within 30 seconds, the notification becomes unavailable to that user and is sent to another candidate user. In some other examples, the predetermined timeout period may be any period of time, such as, for example, 5, 10, 15, 20, 25, or more than 30 seconds.

In some cases, when the notification is a call, the predetermined timeout period may be a number of rings, after which the call-based notification to the candidate user 302 may terminate.

The predetermined number of rings used for the timeout period may be any number of rings, such as, for example, 3, 4, 5, 6, 7, or 8 or more rings. The predetermined number of rings may be dynamically configurable.

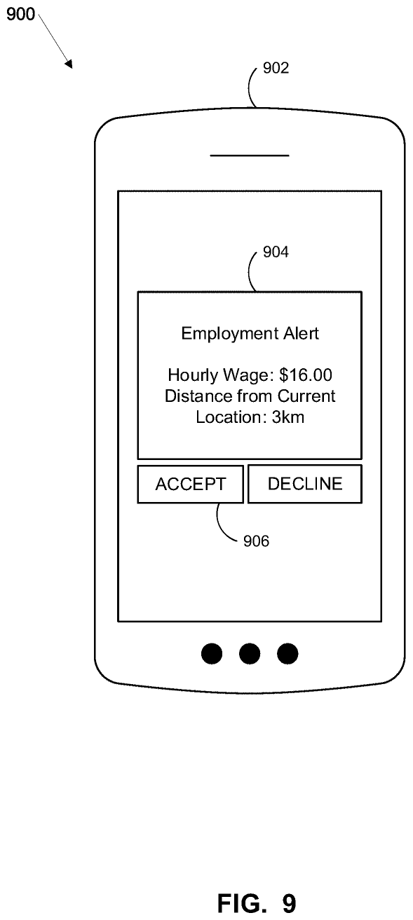

A processing unit, such as processing unit 202a of FIG. 2a may be used to provide the candidate user 302 with employment opportunities within a predetermined geographic range. The candidate user 302 may input information to create a user profile (further described in FIG. 5) to include the candidate user 302 in the search for employment opportunities. In at least one embodiment, based on a location associated with the candidate user computing device 304, the processing unit will determine if the candidate user 302 is within a predetermined geographic range based on the employment location 306. The processing unit may send a first notification of an employment opportunity to the proximate candidate user computing device 304 (further described in FIG. 9). The processing unit may then receive a corresponding confirmation from the participating candidate user computing device 304 as an indication of interest in the employment opportunity.

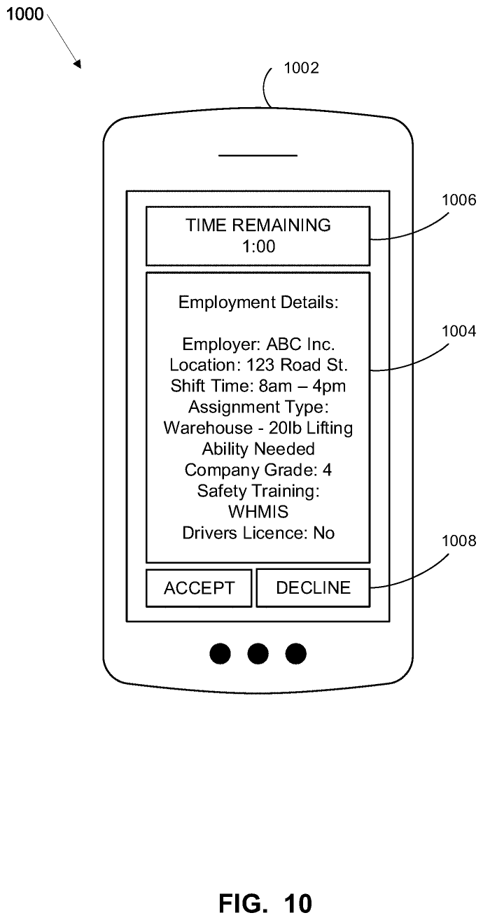

The processing unit may then transmit a second notification to the participating candidate user computing device 304 that provided an indication of interest to the first notification (further detail described in FIG. 10). The processing unit may then receive a corresponding confirmation from the selected participating candidate user computing device 304 as an indication of acceptance of the employment opportunity.

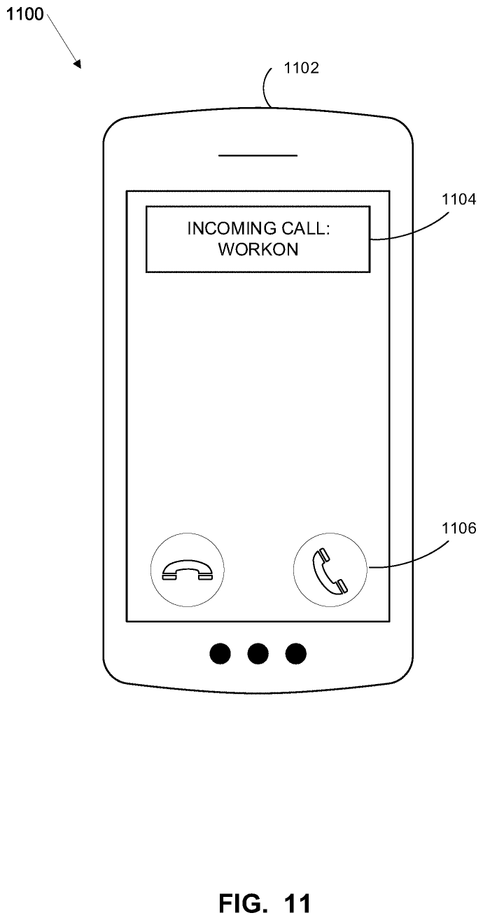

The processing unit may then transmit a third notification to the selected participating candidate user computing device 304 (further detail described in FIG. 11). The processing unit may then receive a corresponding confirmation from the selected participating candidate user computing device 304 as a confirmation of acceptance of the employment opportunity.

If the candidate user 302 confirms the acceptance of the employment opportunity, they may proceed to the employment location 306. Before the employment opportunity begins, the candidate user computing device 308 may send a GPS signal of the location to the employer, to indicate when the candidate user 302 is located at the employment location. The GPS signal may be kept on during the shift and turned off during the lunch break of the candidate user 302 and when the shift is completed. This may allow the employer to be aware of the candidate user being late or not present at the employment opportunity at all.

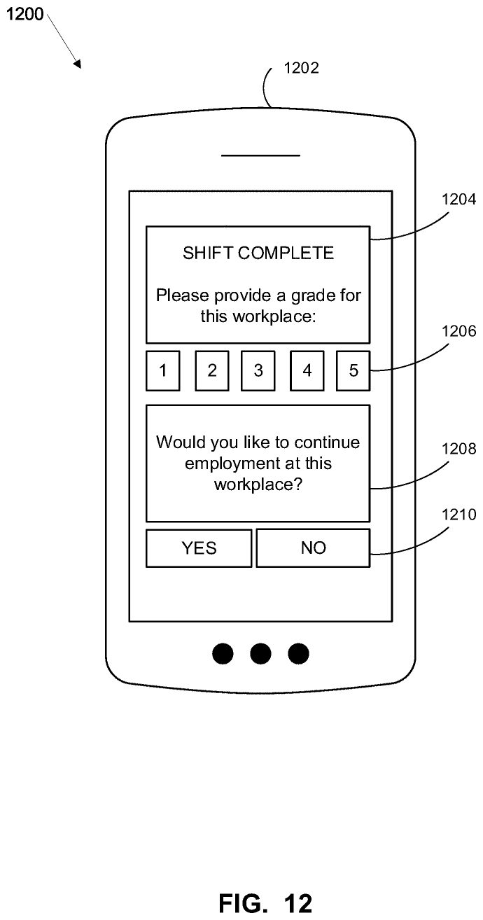

After the employment opportunity is completed, the candidate user 302 may receive payment for the employment on the candidate user computing device 310 (further described in FIG. 12).

Referring next to FIG. 4, which shows a flowchart illustrating a method or process 400 for a notification system according to one example. Method 400 may be carried out by various components of various systems disclosed herein.

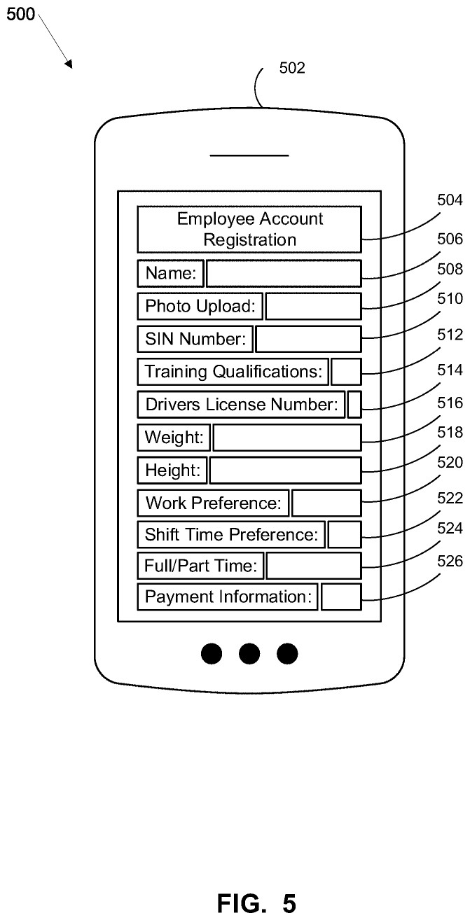

The method 400 for notifying users of employment opportunities may include transmitting three notifications of employment opportunities to a candidate user through a candidate user computing device. In order to transmit the notifications, the candidate user may be determined to be in a location within a predetermined geographic range and fulfill the requirements set out by the employer for the employment opportunity (see FIG. 6).

The method 400 may provide employers with candidate users for use during an employment opportunity. The three-step acceptance process may provide the employer with a candidate user for the employment opportunity who is more likely to show up for employment, as indication of interest, indication of acceptance, and confirmation of acceptance of the employment opportunity is required before the candidate user has accepted the position. This may be useful for employers, as the three-step process may deter candidate users who are not certain of the employment opportunity.

At 402, the method consists of, based on the location of the candidate user computing devices, determining at least one candidate user computing device within a predetermined geographic range around an employer location. The method could, in another embodiment, consist of determining a candidate user computing device based on factors input by the candidate user that align with the factors requested by the employer, as described further in relation to FIG. 3.

At 404, transmitting a first notification to the candidate user computing device. The first notification may include information such as, for example, the employer name, the employer location, and the hourly wage. The first notification may further include other information related to the employment opportunity, as described in relation to FIG. 9.

At 406, the candidate user may input a response to the first notification to indicate that they are interested in the employment opportunity. The candidate user may input a response to indicate that they are not interested in the employment opportunity. The response is sent to the network interface. Further information on the indication of interest of the first notification is described in FIG. 9.

At 408, a second notification is sent to the candidate user computing device. The second notification may include, for example, details corresponding to the employment opportunity such as shift timing, employer rating, training requirements, driver license requirements, assignment type, or any other information as described in FIG. 10.

At 410, the candidate user may input a response to the second notification to indicate that they are interested in the employment opportunity. The candidate user may input a response to indicate their acceptance of the employment opportunity. The candidate user may also input a response to decline the employment opportunity. The second notification may further include, in one embodiment, a timer to notify the candidate user that they have to accept or decline the employment opportunity within that time. In said embodiment, if the timer runs out before the candidate user makes a selection, the employment opportunity is declined on behalf of the candidate user. Further information on the acceptance of the employment opportunity is described in FIG. 10.

At 412, a third notification is sent to the candidate user computing device. The third notification may be in the form of an automated phone call, a phone call, a text message, an email, an alert, or any other form of notification. The third notification may allow the candidate user to confirm their acceptance of the employment opportunity or decline the employment opportunity.

Referring next to FIG. 5, there is shown an example of a user interface 500 for interaction and notification in accordance with one or more embodiments.

A candidate user operates the user interface 502 that includes the system described in FIG. 4. The candidate user inputs information to create an employee account 504. In order to create the employee account 504, the candidate user provides his or her name 506. The candidate user may provide additional information, such as, for example, a photo 508, SIN number 510, training qualifications 512, safety training (not shown), drivers license number 514, weight 516, height 518, work preference 520 of the candidate user, shift time preference 522 of the candidate user, whether the candidate user prefers a full time or a part time position 524, payment information 526, or a combination of one or more of these. In some other cases, other identification information may be provided by the candidate user. The information required to be provided by the candidate to create an employee account 504 may be dynamically changeable. After the required information has been input, the candidate user account is created (not shown).

Referring next to FIG. 6, there is shown an example of a user interface 600 for interaction and notification in accordance with one or more embodiments.

An employer operates an employer interface 602 that includes the system described in FIG. 4. The employer inputs information to create a job posting 604, where the information provided by the employer may include, in some examples, one or more of the following: the name of the employer company 606, the hourly wage 610 and the shift start 612 and end time 614. In some other cases, the information may further include, for example, the type of assignment 608 being posted, the number of employees 616 required for the shift, the training requirements 618 for the candidate user, the lifting requirements 620 for the candidate user, the maximum distance away 622 from the employer location the candidate user should be, or a combination of one or more of these. In some further cases, other additional information to assist in shift scheduling with appropriate users can be provided. The information required to be provided by the employer may be dynamically changeable. After the required information has been input, the job posting is created (not shown).

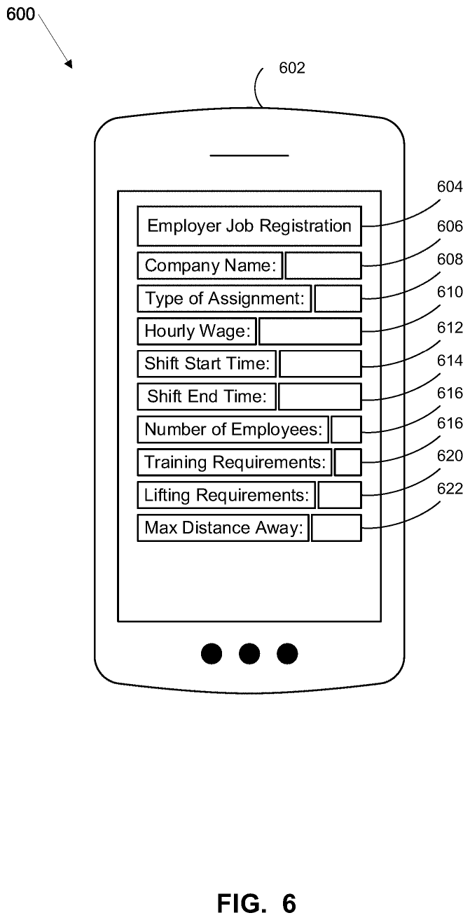

Referring next to FIG. 7, there is shown an example of a user interface 700 for interaction and notification in accordance with one or more embodiments.

A candidate user may operate the user interface 702 that includes the system described in FIG. 4 as shown. The candidate user interface 702 may show a map system as seen by the user. The map system may identify the location of the candidate user 704 and the location of the employment opportunity 706. The map system may further identify locations of other employment opportunities within a predetermined geographic range from the candidate user. The map system may also include locations of other candidate users within a predetermined geographic range from the candidate user.

In some embodiments, the candidate user interface 702 may provide the job information to the candidate user in, for example, a tabular format, a list format, a chart format, or any other format of presenting job information. The candidate user may be able to select the way the job information is presented. In one embodiment, the candidate user may originally view the job information in a map format, and then change the view to a list format. The candidate user may further choose the way the job information is sorted. In any of the formats listed above, the job information may be, for example, sorted in any order, such as ascending by location, descending by location, highest paying to lowest paying, relevance of assignment type based on candidate user preference, highest ranking employer to lowest ranking employer, or any other order as selected by the candidate user.

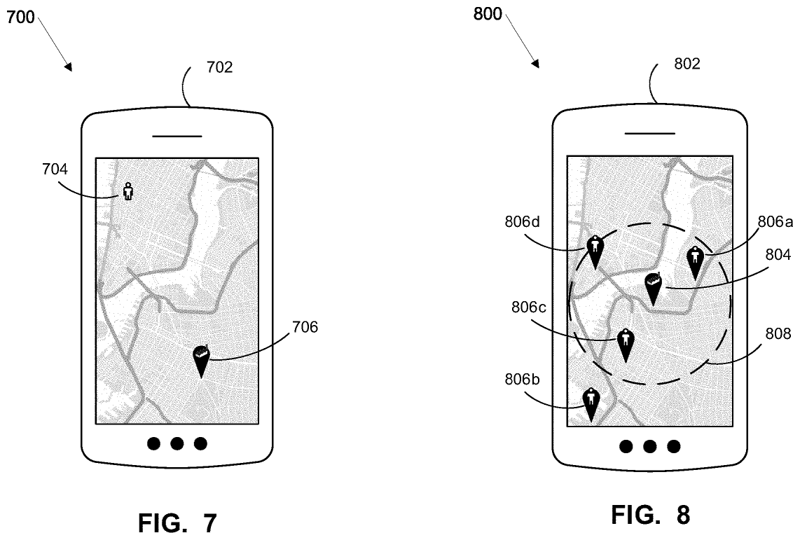

Referring next to FIG. 8, there is shown an example of a user interface 800 for interaction and notification in accordance with one or more embodiments.

An employer may operate the employer interface 802. The employer interface 802 may show a map system as seen by the employer. The map system may identify the location of the employer 804 and the location of proximate candidate user computing devices 806a-d. The proximate candidate user computing devices may correspond to those of a user interface 108a-d from FIG. 1, for example. The may system may further identify the proximate candidate user computing devices 806 that are within the predetermined geographic range 808 based on the employer location 804.

In some embodiments, the employer interface 802 may provide the proximate candidate computing device information to the employer in, for example, a tabular format, a list format, a chart format, or any other format of presenting job information. The employer may be able to select the way the candidate computing device information is presented. In one embodiment, the employer may originally view the job information in a map format, and then change the view to a list format. The employer may further choose the way the candidate computing device information is sorted. In any of the formats listed above, the information may be, for example, sorted in any order, such as ascending by location, descending by location, highest ranking candidate user to lowest ranking candidate user, candidate user that has worked the most with the employer previously to candidate user that has worked the least with the employer previously, most relevant candidate user based on job requirements to least relevant candidate user based on job requirements, or any other order as selected by the candidate user.

Referring next to FIG. 9, there is shown another example of a user interface 900 for interaction and notification in accordance with one or more embodiments.

A candidate user may operate the candidate user computing device 902. The system, after receiving information on the employment opportunity (as shown in FIG. 6), will transmit a first employment alert 904 to candidate user computing devices used by candidate users within a predetermined geographic location. The first employment alert 904 may provide the candidate user with information on the employment opportunity, such as hourly wage and distance from the current location of the candidate user computing device. The first employment alert 904 may include other information relevant to the employment opportunity, such as, for example, the employer name, the employer location, the shift time, the assignment type, the rating of the employer, the safety training required, drivers license requirements, insurance provided by the employer, or other employer information. In some embodiments, the first employment alert 904 may provide the candidate user with an input option 906 to accept and/or decline the employment opportunity. The user interface 900 may be displayed for a predetermined period of time to a candidate user. For example, the user interface 900 may be displayed for 9, 10, 15, 30, or 60 seconds to the candidate user. If no acceptance is made, the alert 904 may be automatically declined at the end of the predetermined time period. The predetermined period of time to display the user interface 900 may be configurable by the employer.

The system may determine a list of the candidate user computing devices that have indicated interest in the employment opportunity. This list may be ordered based upon a specified ordering criteria. Some examples of ordering criteria may include chronological order of the time the indication of interest was received, geographic distance of the candidate user computing device to the employer location, the rating of the candidate user, prior employment of the candidate user with the employer, or other ordering criteria. The ordering criteria may be pre-configured, or may be dynamically configurable by the employer operating the employer computing device (not shown).

Referring next to FIG. 10, there is shown another example of a user interface 1000 for interaction and notification in accordance with one or more embodiments.

In some embodiments, after indicating interest in the employment opportunity from the first employment alert 904, the selected candidate user will receive from the system, a second employment alert 1004 to their respective candidate user computing device 1002. The second employment alert 1004 may be received by the selected candidate user immediately after the indication of interest in the employment opportunity on the first employment alert 904. The second employment alert 1004 may provide the candidate user with further information on the employment opportunity. Some examples of such information may include the name of the employer, the location of the employment opportunity, the shift time, the assignment type, the rating of the company, the safety training required, whether a driver license is required, and whether insurance is provided by the employer. The second employment alert 1004 may further include, for example, whether the employment is a single shift or multiple shifts, the number of employees requested by the employer, the name of the shift supervisor, links to the company policies, links to the company website, contact information of the employer and/or shift supervisor, or any other information indicative of the employment opportunity.

The second employment alert 1004 may include a timer 1006 set for a predetermined duration of time. The second employment alert 1004 may further include an input option 1008 for the candidate user to accept the employment opportunity and/or decline the employment opportunity. The system may, if the candidate user does not choose an input option within the predetermined time limit set by the timer 1006, decline the second employment alert 1004 on behalf of the candidate user.

Where the candidate user declines the second employment alert 1004, or alternatively does not provide any input within the predetermined duration of time, another participating candidate user computing device 1002 may be selected from the list of candidate user computing devices that have indicated acceptance of the employment opportunity. The other candidate user computing device 1002 may then be sent the second employment alert 1004. This process may continue until there is acceptance of the second employment alert 1004.

The second employment alert 1004 may further be sent to the indicated number of candidate users needed by the employer, as indicated during the employer job registration (FIG. 6).

Referring next to FIG. 11, there is shown another example of a user interface 1100 for interaction and notification in accordance with one or more embodiments.

After indicating acceptance of the employment opportunity from the second employment alert 1004, the selected candidate user will receive from the system, a third employment alert 1104 to their respective candidate user computing device 1102. The third employment alert 1104 may provide the candidate user with an input option 1106. In one embodiment (as shown in FIG. 11), the third employment alert 1104 may be in the form of an automated phone call. The candidate user may answer the call and confirm acceptance by saying a word or phrase, inputting a numbered input, or any other indication of confirmation of acceptance. In another embodiment (not shown), the third employment alert 1104 may be in the form of an automated text message. The candidate user may reply to the message with a word or phrase, input a numbered input, or any other indication of confirmation of acceptance.

Referring next to FIG. 12, there is shown another example of a user interface 1200 for interaction and notification in accordance with one or more embodiments.

After completion of the employment opportunity by a candidate user, the system may provide an interface on the candidate user computing device 1202 to receive feedback on the employment opportunity. The interface may include a ranking interface 1204. The ranking interface 1204 may allow the candidate user to input a value 1206 to describe the workplace, such as a number value from 1 to 5, a number value from 1-10, a star value, or any other ranking value. The ranking interface may further allow the candidate user to input written feedback of the workplace.

The shift completion interface may further include a continuation option 1208 for the candidate user to indicate their interest in continuing employment at the workplace. The candidate user may input an indication of interest 1210 in employment continuation. The indication of interest 1210 may include a yes option, a no option, or any other indication.

Shift completion may also allow the candidate user to request payment. If the candidate user has input payment information during the account creation process, they may request to receive payment from the employer as soon as the shift has completed. The system may send payment directly to the bank account of the candidate user.

In one embodiment, the payment system is able to transmit monetary compensation to the candidate user on the same day that their employment has been completed. For example, after completion of one employment opportunity, the candidate user may select to receive payment for their services immediately. The system may, for example, have a select amount of funds on hand to allow for payment to be received by the candidate user immediately. The employer may later be sent a bill for the candidate users employment by the system to reimburse for the pre-payment of the candidate users monetary compensation.

In some embodiments, the payment system is only able to transmit fiat currency to a candidate user after completion of their employment. In another embodiment, the payment system is, additionally or alternatively, able to transmit cryptocurrency compensation to the candidate user. This can be in a variety of cryptocurrencies as known, such as Bitcoin, Ethereum, Dogecoin, Litecoin or others. The cryptocurrency may be another first party cryptocurrency controlled by the employer or by the payment system.

In various cases, the candidate user may indicate their preference of the fiat and/or the cryptocurrency they intend to be paid in. In such cases, the payment is accordingly made in that currency selected by the candidate user.

In some embodiments, the candidate user may select to be paid for their employment on a weekly, monthly, bi-weekly, bi-monthly, yearly, bi-yearly, daily, or any basis that is offered to them through the system. The candidate user may receive their monetary compensation by way of cheque, certified cheque, direct transfer into their bank account, a cryptocurrency deposit to their account on an exchange, wallet or otherwise, or through any other means requested by said candidate user.

Employers may, in one embodiment, receive an electronic bill (not shown) in the form of a report to indicate payments required for the candidate users who have completed employment opportunities. The electronic bill may include, for example, the weekly total wages for a candidate user, the number of times the associate was late for the employment opportunity, the number of times the associate was late returning to the employment opportunity after lunch, or any other information that may indicate payment changes for the candidate user.

In one embodiment, the employer may choose to provide payment to the system by cheque, certified cheque, direct transfer from a company account, direct transfer from an individual account, cryptocurrency wallet, or through any other means as requested by said employer.

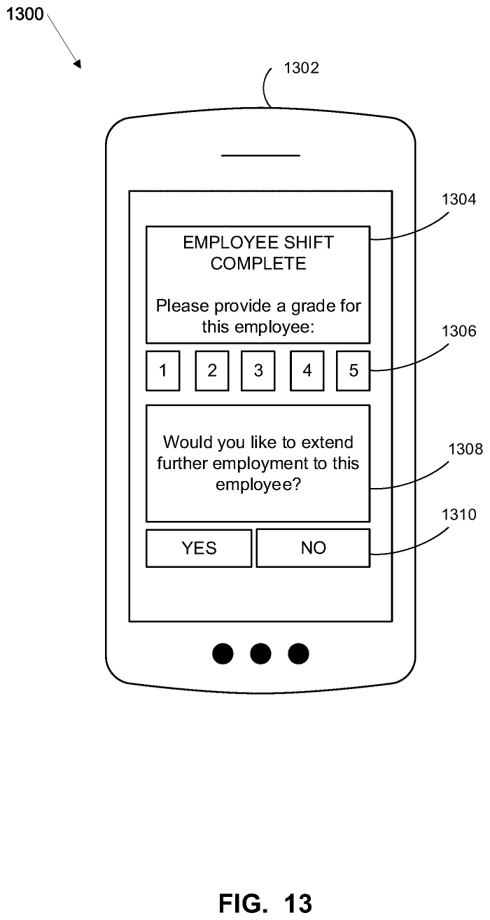

Referring next to FIG. 13, there is shown another example of a user interface 1300 for interaction and notification in accordance with one or more embodiments.

After completion of the employment opportunity by a candidate user, the system may provide an interface on the employer computing device 1302 to receive feedback on the candidate user. The interface may include a ranking interface 1304. The ranking interface 1304 may allow the employer to input a value 1306 to describe the candidate user, such as a number value from 1 to 5, a number value from 1-10, a star value, or any other ranking value. The ranking interface may further allow the employer to input written feedback of the candidate user.

The shift completion interface may further include a continuation option 1308 for the employer to indicate their interest in having the candidate user continue employment at the workplace. The employer may input an indication of interest 1310 in employment continuation. The indication of interest 1310 may include a yes option, a no option, or any other indication.

The candidate user may receive a further rank from the software application itself. This rank may be based on punctuality for the shift (time in and out), shift acceptance rate, shift cancellation amount, or another basis for an employee rank.

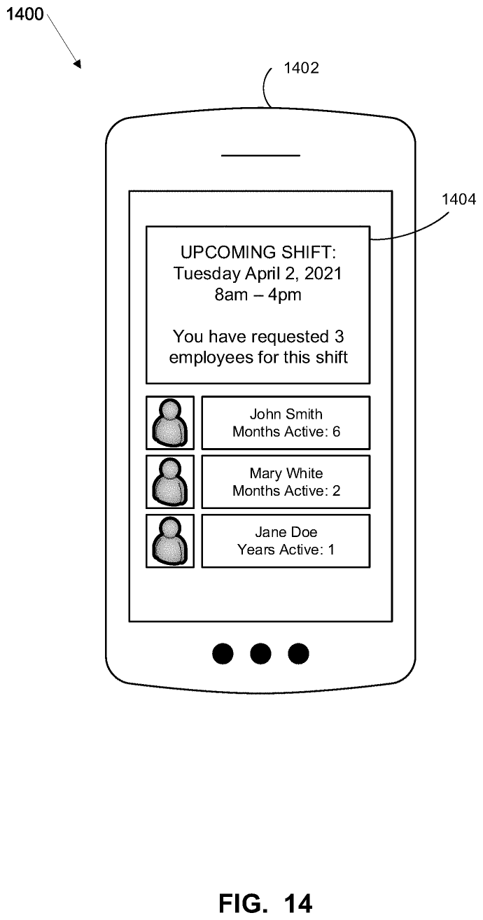

Referring next to FIG. 14, there is shown another example of a user interface 1400 for interaction and notification in accordance with one or more embodiments.

The employer computing device 1402 may provide the employer with an employee interface 1404 to indicate the candidate users who have accepted the employment opportunity. The employee interface 1404 may show the employer the date and time of the shift, how many employees are scheduled to work, the names of the employees, photos of the employees, time the employees have been active on the software application, employee rank, or any other information relevant to the shift.

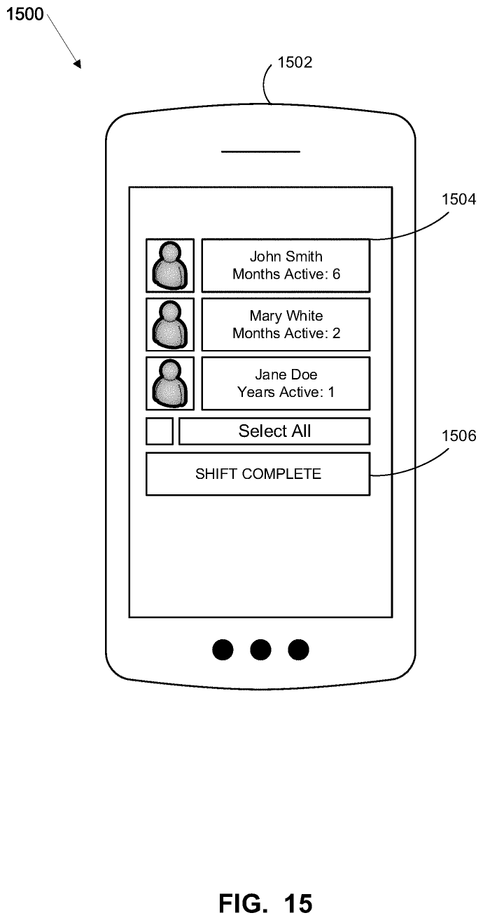

Referring next for FIG. 15, there is shown another example of a user interface 1500 for interaction and notification in accordance with one or more embodiments.

The employer computing device 1502 may provide the employer with an employee interface 1504 to indicate the candidate users who have completed the employment opportunity. The employee interface 1504 may show, for example, the employer the date and time of the shift, how many employees are scheduled to work, the names of the employees, photos of the employees, time the employees have been active on the software application, employee rank, or any other information relevant to the shift.

The employee interface may include a confirmation input 1506 to indicate that the shift has been completed. The employee interface may further include an option to select all employees to mark the shift completed by the confirmation input 1506.

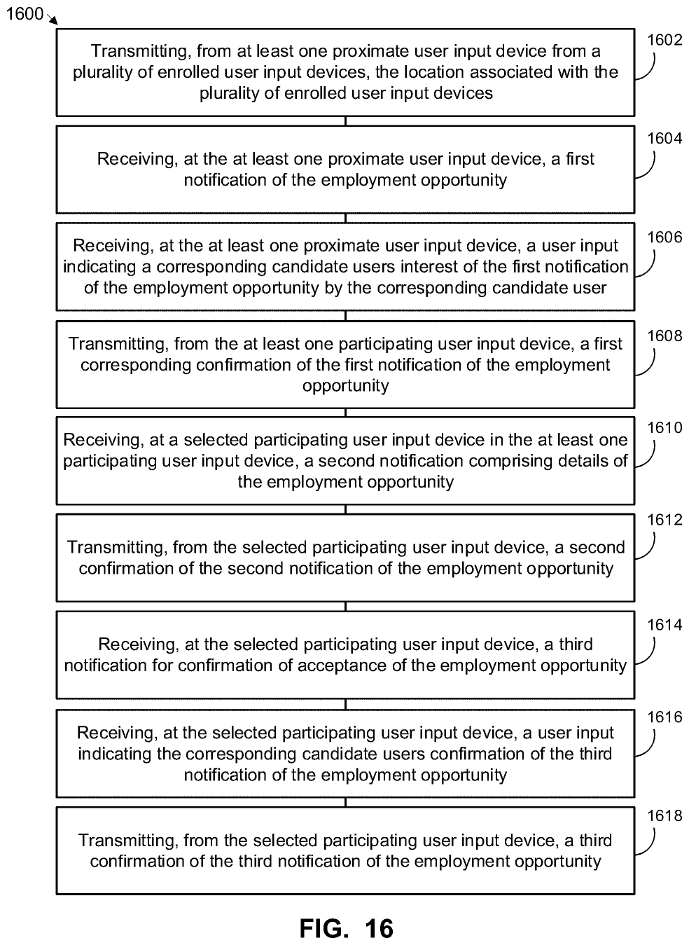

Referring next to FIG. 16, which shows a flowchart illustrating a method or process 1600 for a notification system according to one example. Method 1600 may be carried out by various components of various systems disclosed herein.

The method 1600 for notifying candidate users of employment opportunities may include receiving three notifications of employment opportunities to a candidate user through a user input device. In order to receive the notifications, the user input device may transmit a location, wherein the location is within a predetermined geographic range and the candidate user fulfills the requirements set out by the employer for the employment opportunity (see FIG. 6).

At 1602, a candidate user computing device transmits a location associated with the candidate user computing device. For example, the location could be that of the device itself, or a location input by the candidate user, such as a home location, if they are not there physically at the time. In another embodiment, the candidate user computing device may not transmit the associated location. In said embodiment, the candidate user computing device may provide the employer with information relating to their preferred job type, shift time, full/part time, or any other information provided in the candidate user profile, as described in FIG. 5.

At 1604, the candidate user computing device receives a first notification of an employment opportunity. The first notification may include information such as the employer name, employer location, time of shift, type of assignment, hourly wage, distance from current location, or other information related to the employment opportunity, as further described in FIG. 9.

At 1606, the candidate user may input a response to the first notification to indicate that they are interested in the employment opportunity. The candidate user may input a response to indicate that they are not interested in the employment opportunity. Further information on the indication of interest of the first notification is described in FIG. 9.

At 1608, the candidate user computing device may then be transmitted to the network interface.

At 1610, the candidate user computing device receives a second notification of an employment opportunity. The second notification may include information such as the employer name, employer location, time of shift, type of assignment, hourly wage, distance from current location, or other information related to the employment opportunity, as further described in FIG. 10.

At 1612, the candidate user may input a response to the second notification to indicate acceptance of the employment opportunity, or they may decline the employment opportunity. In one embodiment, the second notification may include a timer wherein the candidate user must input a response to the second notification within a predetermined time limit. In said embodiment, if the candidate user does not response within said predetermined time limit, the candidate user will have been assumed to decline the employment opportunity. Further information regarding the second notification may be found in FIG. 10. The response input may then be transmitted to the network interface.

At 1614, the candidate user receives a third notification of the employment opportunity. The second notification may be in the form of an automated phone call, a phone call, a text message, an email, an alert, or any other notification form, as further described in FIG. 11.

At 1616, the candidate user may input a response to the third notification to confirm acceptance of the employment opportunity. The candidate user may, for example, decline the employment opportunity, as further described in FIG. 11.

At 1618, the candidate user computing device may then transmit said indicated response by the candidate user to the network interface.

The present invention has been described here by way of example only. Various modifications and variations may be made to these exemplary embodiments without departing from the spirit and scope of the invention, which is limited only by the appended claims.

Items:

ITEM 1: A notification system, the system comprising:
a network interface in communication with at least one candidate computing device, each candidate computing device corresponding to a candidate user;
a processor in communication with the network interface, the processor configured to:
   determine at least one proximate candidate computing device from a plurality of enrolled candidate computing devices based on a location associated with the plurality of enrolled candidate computing devices and a predetermined geographic range based on an employer location;
   transmit, from the network interface to the at least one proximate candidate computing device, a first notification of an employment opportunity;
   receive, from the network interface, a corresponding first confirmation from one or more participating candidate computing devices of the at least one proximate candidate computing device, each first confirmation for an indication of interest in the employment opportunity by a respective candidate user;
   transmit, from the network interface, a second notification to a selected participating candidate computing device from the one or more participating candidate computing devices, the second notification comprising details of the employment opportunity for the corresponding candidate user at the selected participating candidate computing device;
   receive, from the network interface, a second confirmation from the selected participating candidate computing device, the second confirmation for an indication of acceptance of the employment opportunity by the corresponding candidate user at the selected participating candidate computing device; and
   transmit, from the network interface to the selected participating candidate computing device, a third notification for confirmation of acceptance of the employment opportunity.
      ITEM 2: The system of any preceding item, wherein the location associated with the plurality of enrolled candidate computing devices is based on geographic positioning data of the at least one proximate candidate computing device.
      ITEM 3: The system of any preceding item, wherein the location associated with the plurality of enrolled candidate computing devices is based on a geographic location specified by the candidate user.
      ITEM 4: The system of any preceding item, wherein the processor is further configured to determine a list of the one or more participating candidate computing devices, the list ordered based upon an ordering criteria.
      ITEM 5: The system of any preceding item, wherein the ordering criteria is based on at least one criterion selected from the group consisting of: chronological order based on the time the corresponding candidate user's first confirmation was received, geographic distance of the respective candidate computing device from the employer location, rating of the corresponding candidate user, and prior employment of the corresponding candidate user with the same employer.
      ITEM 6: The system of any preceding item, wherein the processor is further configured to:
receive, from the network interface, a rejection of the second notification from the selected participating candidate computing device, the rejection of the second notification for an indication of the corresponding candidate user declining the employment opportunity;
determine another participating candidate computing device from the list, the other participating candidate computing device selected from the list based on the ordering criteria;
transmit, from the network interface, a second notification to the other participating candidate computing device from the one or more participating candidate computing devices.
   ITEM 7: The system of any preceding item, wherein the first notification comprises at least one indicator selected from the group consisting of: the distance from the proximate candidate computing device to the employer location, and the hourly wage of the employment opportunity.
   ITEM 8: The system of any preceding item, wherein the second notification comprises at least one indicator selected from the group consisting of: company details, an exact location of the employment opportunity, scheduling information, type of assignment, and company ranking.
   ITEM 9: The system of any preceding item, wherein the processor is further configured to determine an elapsed time indicator between a transmission of the second notification and an arrival of the second confirmation wherein if the elapsed time indicator is greater than a predetermined threshold, the processor is configured to refuse the second confirmation from the participating candidate computing device.
   ITEM 10: The system of any preceding item, wherein the third notification is in the form of an automated phone call.
   ITEM 11: The system of any preceding item, wherein the processor is configured to determine the selected participating candidate computing device based on a number of requested candidate users of the employment opportunity.
   ITEM 12: The system of any preceding item, wherein after the employment opportunity is completed by the candidate user, the processor is configured to receive an employer rank indicator from the at least one candidate computing device, the employer rank indicator corresponding to the employment opportunity.
   ITEM 13: The system of any preceding item, wherein after the employment opportunity is completed by the candidate user, the processor is configured to receive an employee rank indicator from the network interface, the employee rank corresponding to the candidate user.
   ITEM 14: The system of any preceding item, wherein after the employment opportunity is completed by the candidate user, the processor is configured to transmit a payment request to a payment processor for fulfilling payment to the candidate user for the employment opportunity within the same day as the employment opportunity.
   ITEM 15: A computer-implemented method for notification, the method comprising:
determining, at least one proximate candidate computing device from a plurality of enrolled candidate computing devices based on a location associated with the plurality of enrolled candidate computing devices and a predetermined geographic range based on an employer location;
transmitting, from the network interface to the at least one proximate candidate computing device, a first notification of an employment opportunity;
receiving, from the network interface, a corresponding first confirmation from one or more participating candidate computing devices of the at least one proximate candidate computing device, each first confirmation for an indication of interest in the employment opportunity by a respective candidate user;
transmitting, from the network interface, a second notification to a selected participating candidate computing device from the one or more participating candidate computing devices, the second notification comprising details of the employment opportunity for the corresponding candidate user at the selected participating candidate computing device;
receiving, from the network interface, a second confirmation from the selected participating candidate computing device, the second confirmation for an indication of acceptance of the employment opportunity by the corresponding candidate user at the selected participating candidate computing device; and
transmitting, from the network interface to the selected participating candidate computing device, a third notification for confirmation of acceptance of the employment opportunity.
   ITEM 16: The method of any preceding item, wherein the location associated with the plurality of enrolled candidate computing devices is based on geographic positioning data of the at least one proximate candidate computing system.
   ITEM 17: The method of any preceding item, wherein the location associated with the plurality of enrolled candidate computing devices is based on a geographic location specified by the candidate user.
   ITEM 18: The method of any preceding item, wherein the method further comprises determining a list of the one or more participating candidate computing devices, the list ordered based upon an ordering criteria.
   ITEM 19: The method of any preceding item, wherein the ordering criteria is based on at least one criterion selected from the group consisting of: chronological order based on the time the corresponding candidate user's first confirmation was received, geographic distance of the respective candidate computing device from the employer location, rating of the corresponding candidate user, and prior employment of the corresponding candidate user with the same employer.
   ITEM 20: The method of any preceding item, wherein the method further comprises:
receiving, from the network interface, a rejection of the second notification from the selected participating candidate computing device, the rejection of the second notification for an indication of the corresponding candidate user declining the employment opportunity;
determining another participating candidate computing device from the list, the other participating candidate computing device selected from the list based on the ordering criteria;
transmitting, from the network interface, a second notification to the other participating candidate computing device from the one or more participating candidate computing device.
   ITEM 21: The method of any preceding item, wherein the first notification comprises at least one indicator selected from the group consisting of: the distance from the proximate candidate computing device to the employer location, and the hourly wage of the employment opportunity.
   ITEM 22: The method of any preceding item, wherein the second notification comprises at least one indicator selected from the group consisting of: company details, an exact location of the employment opportunity, scheduling information, type of assignment, and company ranking.
   ITEM 23: The method of any preceding item, wherein the method further comprises determining an elapsed time indicator between a transmission of the second notification and an arrival of the second confirmation wherein if the elapsed time indicator is greater than a predetermined threshold, the second confirmation from the participating candidate computing device is refused.
   ITEM 24: The method of any preceding item, wherein the third notification is in the form of an automated phone call.
   ITEM 25: The method of any preceding item, wherein the method further comprises determining the selected participating candidate computing device based on a number of requested candidate users of the employment opportunity.
   ITEM 26: The method of any preceding item, wherein after the employment opportunity is completed by the candidate user, the method further comprises receiving an employer rank indicator from the at least one candidate computing device, the employer rank indicator corresponding to the employment opportunity.
   ITEM 27: The method of any preceding item, wherein after the employment opportunity is completed by the candidate user, the method further comprises receiving an employee rank indicator from the network interface, the employee rank indicator corresponding to the candidate user.
   ITEM 28: The method of any preceding item, wherein after the employment opportunity is completed by the candidate user, the method further comprises transmitting a payment request to a payment processor from the network interface, the payment request configured to fulfill payment to the candidate user for the employment opportunity within the same day as the employment opportunity.
   ITEM 29: A notification system, the system comprising:
at least one user input device, each user input device corresponding to a candidate user;
a network interface in communication with a server;
a processor in communication with the user input device and the network interface, the processor configured to:
   transmit, from at least one proximate user input device from a plurality of enrolled user input devices, a location associated with the plurality of enrolled user input devices;
   receive, at the at least one proximate user input device, a first notification of an employment opportunity;
   receive, at the at least one proximate user input device, a user input indicating a corresponding candidate users interest of the first notification of the employment opportunity by the corresponding candidate user;
   transmit, from the at least one participating user input device, a corresponding first confirmation of the first notification of the employment opportunity;
   receive, at a selected participating user input device in the at least one participating user input device, a second notification comprising details of the employment opportunity;
   receive, at the selected participating user input device, a user input indicating the corresponding candidate users acceptance of the second notification of the employment opportunity by the corresponding candidate user;
   transmit, from the selected participating user input device, a second confirmation of the second notification of the employment opportunity;
   receive, at the selected participating user input device, a third notification for confirmation of acceptance of the employment opportunity;
   receive, at the selected participating user input device, a user input indicating the corresponding candidate users confirmation of the third notification of the employment opportunity; and
   transmit, from the selected participating user input device, a third confirmation of the third notification of the employment opportunity.
      ITEM 30: The system of any preceding item, wherein the location associated with the plurality of enrolled user input devices is based on geographic positioning data of the at least one proximate user input device.
      ITEM 31: The system of any preceding item, wherein the location associated with the at least one proximate user input device is based on a geographic location specified by the candidate user.
      ITEM 32: The system of any preceding item, wherein the network interface is configured to determine a list of one or more participating user input devices, the list ordered based upon an ordering criteria.
      ITEM 33: The system of any preceding item, wherein the ordering criteria is based on at least one criterion selected from the group consisting of: chronological order based on the time the user input indicating the corresponding candidate user's first confirmation was transmit, geographic distance of the respective user input device from the employer location, rating of the corresponding candidate user, and prior employment of the corresponding candidate user with the same employer.
      ITEM 34: The system of any preceding item, wherein the processor is further configured to:
transmit, from the selected participating user input device, a rejection of the second notification, the rejection of the second notification for an indication of the corresponding candidate user declining the employment opportunity; determine another participating user input device from the list, the other participating user input device selected from the list based on the ordering criteria;
receive, at the other participating user input device, a second notification to the other participating user input device from the one or more participating user input devices.
   ITEM 35: The system of any preceding item, wherein the first notification comprises at least one indicator selected from the group consisting of: the distance from the proximate user input device to the employer location, and the hourly wage of the employment opportunity.
   ITEM 36: The system of any preceding item, wherein the second notification comprises at least one indicator selected from the group consisting of: company details, an exact location of the employment opportunity, scheduling information, type of assignment, and company ranking.
   ITEM 37: The system of any preceding item, wherein the processor is further configured to determine an elapsed time indicator between an arrival of the second notification and a transmission of the second confirmation wherein if the elapsed time indicator is greater than a predetermined threshold, the processor is configured to refuse the second confirmation from the participating user input device.
   ITEM 38: The system of any preceding item, wherein the third notification is in the form of an automated phone call.
   ITEM 39: The system of any preceding item, wherein the processor is configured to determine the selected participating user input device based on a number of requested candidate users of the employment opportunity.
   ITEM 40: The system of any preceding item, wherein after the employment opportunity is completed by the candidate user, the processor is configured to receive an employer rank indicator from the at least one user input device, the employer rank indicator corresponding to the employment opportunity.
   ITEM 41: The system of any preceding item, wherein after the employment opportunity is completed by the candidate user, the processor is configured to receive an employee rank indicator from the network interface, the employee rank corresponding to the candidate user.
   ITEM 42: The system of any preceding item, wherein after the employment opportunity is completed by the candidate user, the processor is configured to transmit a payment request to a payment processor for fulfilling payment to the candidate user for the employment opportunity within the same day as the employment opportunity.
   ITEM 43: The system of any preceding item, wherein the payment processor is a cryptocurrency network, optionally one of Bitcoin, Ethereum, Dogecoin, or Litecoin.
   ITEM 44: A notification method, the method comprising:
transmitting, from at least one proximate user input device from a plurality of enrolled user input devices, the location associated with the plurality of enrolled user input devices;
receiving, at the at least one proximate user input device, a first notification of the employment opportunity;
receiving, at the at least one proximate user input device, a user input indicating a corresponding candidate users interest of the first notification of the employment opportunity by the corresponding candidate user;
transmitting, from the at least one participating user input device, a first corresponding confirmation of the first notification of the employment opportunity;
receiving, at a selected participating user input device in the at least one participating user input device, a second notification comprising details of the employment opportunity;
receiving, at the selected participating user input device, a user input indicating the corresponding candidate users acceptance of the second notification of the employment opportunity by the corresponding candidate user;
transmitting, from the selected participating user input device, a second confirmation of the second notification of the employment opportunity;
receiving, at the selected participating user input device, a third notification for confirmation of acceptance of the employment opportunity;
receiving, at the selected participating user input device, a user input indicating the corresponding candidate users confirmation of the third notification of the employment opportunity; and
transmitting, from the selected participating user input device, a third confirmation of the third notification of the employment opportunity.
   ITEM 45: The method of any preceding item, wherein the location associated with the plurality of enrolled user input devices is based on geographic positioning data of the at least one proximate user input device.
   ITEM 46: The method of any preceding item, wherein the location associated with the plurality of enrolled user input devices is based on a geographic location specified by the candidate user.
   ITEM 47: The method of any preceding item, wherein a network interface in communication with the at least one user input device is configured to determine a list of one or more participating user input devices, the list ordered based upon an ordering criteria.
   ITEM 48: The method of any preceding item, wherein the ordering criteria is based on at least one criterion selected from the group consisting of: chronological order based on the time the corresponding user input indicating the corresponding candidate user's first confirmation was transmit, geographic distance of the respective user input device from the employer location, rating of the corresponding candidate user, and prior employment of the corresponding candidate user with the same employer.
   ITEM 49: The method of any preceding item, wherein the method further comprises:
transmitting, from the selected participating user input device, a rejection of the second notification, the rejection of the second notification for an indication of the corresponding candidate user declining the employment opportunity;
determining another participating user input device, the other participating user input device selected from the list based on the ordering criteria; receiving, at the other participating user input device, a second notification to the other participating user input device in the one or more participating user input devices.
   ITEM 50: The method of any preceding item, wherein the first notification comprises at least one indicator selected from the group consisting of: the distance from the proximate user input device to the employer location, and the hourly wage of the employment opportunity.
   ITEM 51: The method of any preceding item, wherein the second notification comprises at least one indicator selected from the group consisting of: company details, the exact location of the employment opportunity, scheduling information, type of assignment, and company ranking.
   ITEM 52: The method of any preceding item, wherein the method further comprises determining an elapsed time indicator between an arrival of the second notification and a transmission of the second confirmation wherein if the elapsed time indicator is greater than a predetermined threshold, the second confirmation from the participating user input device is refused.
   ITEM 53: The method of any preceding item, wherein the third notification is in the form of an automated phone call.
   ITEM 54: The method of any preceding item, wherein the method further comprises determining the selected participating user input device based on a number of requested candidate users of the employment opportunity.
   ITEM 55: The method of any preceding item, wherein after the employment opportunity is completed by the candidate user, the method further comprises transmitting a corresponding user input of an employer rank indicator from the at least one user input device, the employer rank indicator corresponding to the employment opportunity.
   ITEM 56: The method of any preceding item, wherein after the employment opportunity is completed by the candidate user, the method further comprises receiving an employee rank indicator from the network interface, the employee rank indicator representing the candidate user.
   ITEM 57: The method of any preceding item, wherein after the employment opportunity is completed by the candidate user, the method further comprises transmitting a payment request to a payment processor from the network interface, the payment request configured to fulfill payment to the candidate user for the employment opportunity within the same day as the employment opportunity.
   ITEM 58: The method of any preceding item, wherein the payment processor is a cryptocurrency network, optionally one of Bitcoin, Ethereum, Dogecoin, Litecoin.

We claim:

1. A notification system, the system comprising:
at least one user input device, each user input device corresponding to a candidate user;
a network interface in communication with a server;
a processor in communication with the user input device and the network interface, the processor configured to:
transmit, from at least one proximate user input device from a plurality of enrolled user input devices, a location associated with the plurality of enrolled user input devices;
receive, at the at least one proximate user input device, a first notification of an employment opportunity;
receive, at the at least one proximate user input device, a user input indicating a corresponding candidate users interest of the first notification of the employment opportunity by the corresponding candidate user;
transmit, from the at least one participating user input device, a corresponding first confirmation of the first notification of the employment opportunity;
receive, at a selected participating user input device in the at least one participating user input device, a second notification comprising details of the employment opportunity;
receive, at the selected participating user input device, a user input indicating the corresponding candidate users acceptance of the second notification of the employment opportunity by the corresponding candidate user;
transmit, from the selected participating user input device, a second confirmation of the second notification of the employment opportunity;
receive, at the selected participating user input device, a third notification for confirmation of acceptance of the employment opportunity;
receive, at the selected participating user input device, a user input indicating the corresponding candidate users confirmation of the third notification of the employment opportunity; and
transmit, from the selected participating user input device, a third confirmation of the third notification of the employment opportunity.

2. The system of claim 1, wherein the location associated with the plurality of enrolled user input devices is based on geographic positioning data of the at least one proximate user input device.

3. The system of claim 1, wherein the location associated with the at least one proximate user input device is based on a geographic location specified by the candidate user.

4. The system of claim 1, wherein the network interface is configured to determine a list of one or more participating user input devices, the list ordered based upon an ordering criteria.

5. The system of claim 4, wherein the ordering criteria is based on at least one criterion selected from the group consisting of: chronological order based on the time the user input indicating the corresponding candidate user's first confirmation was transmit, geographic distance of the respective user input device from the employer location, rating of the corresponding candidate user, and prior employment of the corresponding candidate user with the same employer.

6. The system of claim 4, wherein the processor is further configured to:
transmit, from the selected participating user input device, a rejection of the second notification, the rejection of the second notification for an indication of the corresponding candidate user declining the employment opportunity;
determine another participating user input device from the list, the other participating user input device selected from the list based on the ordering criteria;
receive, at the other participating user input device, a second notification to the other participating user input device from the one or more participating user input devices.

7. The system of claim 1, wherein the first notification comprises at least one indicator selected from the group consisting of: the distance from the proximate user input device to the employer location, and the hourly wage of the employment opportunity.

8. The system of claim 1, wherein the second notification comprises at least one indicator selected from the group consisting of: company details, an exact location of the employment opportunity, scheduling information, type of assignment, and company ranking.

9. The system of claim 1, wherein after the employment opportunity is completed by the candidate user, the processor is configured to transmit a payment request to a payment processor for fulfilling payment to the candidate user for the employment opportunity within the same day as the employment opportunity.

10. The system of claim 9 wherein the payment processor is a cryptocurrency network, optionally one of Bitcoin, Ethereum, Dogecoin, or Litecoin.

11. A notification method, the method comprising:
transmitting, from at least one proximate user input device from a plurality of enrolled user input devices, the location associated with the plurality of enrolled user input devices;
receiving, at the at least one proximate user input device, a first notification of the employment opportunity;
receiving, at the at least one proximate user input device, a user input indicating a corresponding candidate users interest of the first notification of the employment opportunity by the corresponding candidate user;
transmitting, from the at least one participating user input device, a first corresponding confirmation of the first notification of the employment opportunity;
receiving, at a selected participating user input device in the at least one participating user input device, a second notification comprising details of the employment opportunity;
receiving, at the selected participating user input device, a user input indicating the corresponding candidate users acceptance of the second notification of the employment opportunity by the corresponding candidate user;
transmitting, from the selected participating user input device, a second confirmation of the second notification of the employment opportunity;
receiving, at the selected participating user input device, a third notification for confirmation of acceptance of the employment opportunity;
receiving, at the selected participating user input device, a user input indicating the corresponding candidate users confirmation of the third notification of the employment opportunity; and
transmitting, from the selected participating user input device, a third confirmation of the third notification of the employment opportunity.

12. The method of claim 11, wherein the location associated with the plurality of enrolled user input devices is based on geographic positioning data of the at least one proximate user input device.

13. The method of claim 11, wherein the location associated with the plurality of enrolled user input devices is based on a geographic location specified by the candidate user.

14. The method of claim 11, wherein a network interface in communication with the at least one user input device is configured to determine a list of one or more participating user input devices, the list ordered based upon an ordering criteria.

15. The method of claim 14, wherein the ordering criteria is based on at least one criterion selected from the group consisting of: chronological order based on the time the corresponding user input indicating the corresponding candidate user's first confirmation was transmit, geographic distance of the respective user input device from the employer location, rating of the corresponding candidate user, and prior employment of the corresponding candidate user with the same employer.

16. The method of claim 14, wherein the method further comprises:
transmitting, from the selected participating user input device, a rejection of the second notification, the rejection of the second notification for an indication of the corresponding candidate user declining the employment opportunity;
determining another participating user input device, the other participating user input device selected from the list based on the ordering criteria;
receiving, at the other participating user input device, a second notification to the other participating user input device in the one or more participating user input devices.

17. The method of claim 11, wherein the first notification comprises at least one indicator selected from the group consisting of: the distance from the proximate user input device to the employer location, and the hourly wage of the employment opportunity.

18. The method of claim 11, wherein the second notification comprises at least one indicator selected from the group consisting of: company details, the exact location of the employment opportunity, scheduling information, type of assignment, and company ranking.

19. The method of claim 11, wherein after the employment opportunity is completed by the candidate user, the method further comprises transmitting a payment request to a payment processor from the network interface, the payment request configured to fulfill payment to the candidate user for the employment opportunity within the same day as the employment opportunity.

20. The method of claim 19 wherein the payment processor is a cryptocurrency network, optionally one of Bitcoin, Ethereum, Dogecoin, or Litecoin.
